(19) United States
(12) Patent Application Publication
(10) Pub. No.: US 2019/0334205 A1
(43) Pub. Date: Oct. 31, 2019

(54) ALL-SOLID-STATE BATTERY

(71) Applicant: TOYOTA JIDOSHA KABUSHIKI KAISHA, Toyota-shi (JP)

(72) Inventor: Tetsuya WASEDA, Susono-shi (JP)

(73) Assignee: TOYOTA JIDOSHA KABUSHIKI KAISHA, Toyota-shi (JP)

(21) Appl. No.: 16/396,033

(22) Filed: Apr. 26, 2019

(30) Foreign Application Priority Data
Apr. 27, 2018 (JP) 2018-087457

(51) Int. Cl. H01M 10/0562; H01M 10/0525; H01M 10/0585; H01M 4/505; H01M 4/131; H01M 4/38; H01M 4/134; H01M 4/62; B32B 27/08

(52) U.S. Cl. CPC H01M 10/0562; H01M 10/0525; H01M 10/0585; H01M 4/505; H01M 4/131; H01M 2004/027; H01M 4/387; H01M 4/134; H01M 4/621; B32B 27/08; H01M 2220/20; H01M 4/386

(57) ABSTRACT

[OBJECT]

To provide an all-solid-state battery in which the side surface of the all-solid-state battery laminate is covered with a resin layer, wherein adhesiveness between the all-solid-state battery laminate and the resin layer is improved, whereby the all-solid-state battery can be structurally stabilized.

[SOLVING MEANS]

An all-solid-state battery, including an all-solid-state battery laminate including at least one all-solid-state unit cell in which a positive electrode current collector layer, a positive electrode active material layer, a solid electrolyte layer, a negative electrode active material layer, and a negative electrode current collector layer are laminated in this order, and a resin layer covering a side surface of the all-solid-state battery laminate, wherein at least one surface of at least one of the positive electrode current collector layer and the negative electrode current collector layer includes a laminated part and an extending part, the laminated part is a portion which overlaps another adjacent layer, and the extending part is a portion which extends beyond the other adjacent layer, and the surface roughness of the extending part is greater than the surface roughness of the laminated part.

### FIELD

The present disclosure relates to an all-solid-state battery. In particular, the present disclosure relates to an all-solid-state battery comprising an all-solid-state battery laminate and a resin layer covering the all-solid-state battery laminate.

### BACKGROUND

In recent years, in order to improve safety, particular attention has been paid to all-solid-state batteries in which the electrolytic solution is replaced with a solid electrolyte. Various developments relating to all-solid-state battery laminates have been disclosed. For example, Patent Literature 1 discloses a bipolar battery comprising a current collector in which the degrees of surface roughness of the electrode layer-forming portion and the seal member-attaching portion are different. Furthermore, Patent Literature 2 discloses an all-solid-state battery comprising a structure in which electrode collectors having the same polarity and roughened surfaces are laminated so as to face each other.

Furthermore, in order to improve the energy density of all-solid-state batteries, all-solid-state batteries in which, instead of the exterior body, only the side surface of the all-solid-state battery laminate is covered using a resin layer have been reported (for example, Patent Literature 3). In the all-solid-state battery laminate of Patent Literature 3, at least one layer among the current collector layer, the positive electrode mixture layer (positive electrode active material layer), the solid electrolyte layer, and the negative electrode mixture layer (negative electrode active material layer) extends outwardly beyond the other layers to form an extended layer, and a plurality of extending layers extend from the side surface of the laminated battery.

### CITATION LIST

### Patent Literature

[PTL 1] Japanese Unexamined Patent Publication (Kokai) No. 2007-188746

[PTL 2] Japanese Unexamined Patent Publication (Kokai) No. 2017-157271

[PTL 3] Japanese Unexamined Patent Publication (Kokai) No. 2017-220447

### SUMMARY

### Technical Problem

In all-solid-state batteries in which the side surface of the all-solid-state battery laminate is covered with a resin layer, when changes in volume of the all-solid-state battery laminate occur during charging and discharging, the adhesive portion between the all-solid-state battery laminate and the resin layer may peel off, which may cause the structure of the all-solid-state battery to become unstable.

Thus, the present disclosure has been achieved in light of the above problems, and aims to provide a structurally stable all-solid-state battery in which the side surface of the all-solid-state battery laminate is covered with a resin and wherein the adhesiveness between the all-solid-state battery laminate and the resin layer is improved.

### Solution to Problem

The inventors of the present disclosure have discovered that the above problems can be solved by the following means.

### <Aspect 1>

An all-solid-state battery, comprising:

an all-solid-state battery laminate comprising at least one all-solid-state unit cell in which a positive electrode current collector layer, a positive electrode active material layer, a solid electrolyte layer, a negative electrode active material layer, and a negative electrode current collector layer are laminated in this order, and

a resin layer covering a side surface of the all-solid-state battery laminate,

wherein at least one surface of at least one of the positive electrode current collector layer and the negative electrode current collector layer includes a laminated part and an extending part,

wherein the laminated part is a portion which overlaps another adjacent layer, and the extending part is a portion which extends beyond the other adjacent layer, and

wherein the surface roughness of the extending part is greater than the surface roughness of the laminated part.

### <Aspect 2>

The all-solid-state battery according to aspect 1, wherein at least one surface of each of the positive electrode current collector layers and the negative electrode current collector layers includes the laminated part and the extending part.

### <Aspect 3>

The all-solid-state battery according to aspect 1 or 2, wherein both surfaces of at least one of the positive electrode current collector layer and the negative electrode current collector layer include the laminate part and the extending part.

### <Aspect 4>

The all-solid-state battery according to any one of aspects 1 to 3, wherein the positive electrode active material layer and the negative electrode active material layer have different areas.

### <Aspect 5>

The all-solid-state battery according to any one of aspects 1 to 4, wherein the area of the negative electrode active material layer is greater than the area of the positive electrode active material layer.

### <Aspect 6>

The all-solid-state battery according to any one of aspects 1 to 5, wherein the material of the resin layer is a curable resin or a thermoplastic resin.

### <Aspect 7>

The all-solid-state battery according to any one of aspects 1 to 6, wherein the all-solid-state battery laminate is restrained in the lamination direction.

### <Aspect 8>

The all-solid-state battery according to any one of aspects 1 to 7, wherein the all-solid-state battery is an all-solid-state lithium ion secondary battery.

### Advantageous Effects of Invention

According to the present disclosure, there is provided an all-solid-state battery in which the side surface of the all-solid-state battery laminate is covered with a resin layer, wherein adhesiveness between the all-solid-state battery laminate and the resin layer is improved due to an extending part of the current collector layer, which has a relatively high surface roughness, whereby the all-solid-state battery can be structurally stabilized.

Further, according to the present disclosure, by structurally stabilizing the all-solid-state battery, it is possible to promote the dissipation of heat generated inside the battery to the outside of the battery through the resin layer.

### BRIEF DESCRIPTION OF DRAWINGS

FIG. 1 is a schematic cross-sectional view showing an example of the all-solid-state battery according to the present disclosure.

FIG. 2 is a schematic view showing a portion of the all-solid-state battery according to the present disclosure.

FIG. 3 is a schematic cross-sectional view showing an example of the all-solid-state battery according to the present disclosure.

### DESCRIPTION OF EMBODIMENTS

The embodiments of the present disclosure will be described in detail below referring to the drawings. Note that, for the convenience of explanation, in the drawings, the same or corresponding portions are assigned the same reference numerals and duplicate explanations therefor have been omitted. Not all of the constituent elements of the embodiments are necessarily indispensable, and some constituent elements may be optional. Additionally, the forms shown in the drawings below are merely for explaining the present disclosure. The present disclosure is not limited thereto.

### <<All-Solid-State Battery>>

The all-solid-state battery of the present disclosure comprises:

an all-solid-state battery laminate comprising at least one all-solid-state unit cell in which a positive electrode current collector layer, a positive electrode active material layer, a solid electrolyte layer, a negative electrode active material layer, and a negative electrode current collector layer are laminated in this order, and

a resin layer covering the side surface of the all-solid-state battery laminate,

wherein at least one surface of at least one of the positive electrode current collector layer and the negative electrode current collector layer includes a laminated part and an extending part,

wherein the laminated part is a portion which overlaps another adjacent layer, and the extending part is a portion which extends beyond the other adjacent layer, and

wherein the surface roughness of the extending part is greater than the surface roughness of the laminated part.

In the present disclosure, “surface roughness” means the arithmetic average roughness (Ra) as measured in accordance in JIS B0601 (1994). Specifically, the arithmetic average roughness (Ra) is represented by the following formula:

$$Ra = \frac{1}{L} {\int }_{0}^{L} \vert f ( x ) \vert dx \qquad [ Math 1 ]$$

wherein a portion of a reference length L is extracted from the roughness curve in the direction of the center line, the center line of the extracted portion is the X-axis, the direction of the longitudinal magnification is the Y-axis, and the roughness curve is expressed as y=f(x). Note that, the reference length L can be determined in accordance with JIS B0633 (2001).

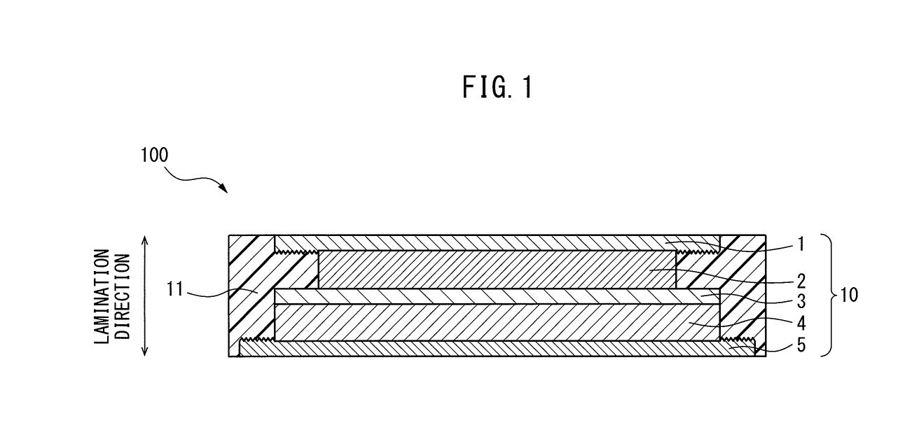

FIG. 1 is a schematic cross-sectional view showing an example of the all-solid-state battery of the present disclosure. The all-solid-state battery 100 of the present disclosure comprises an all-solid-state battery laminate 10, and a resin layer 11 covering the side surface of the all-solid-state battery laminate 10. The all-solid-state battery laminate 10 comprises a single all-solid-state unit cell comprising a positive electrode current collector layer 1, a positive electrode active material layer 2, a solid electrolyte layer 3, a negative electrode active material layer 4, and a negative electrode current collector layer 5 laminated in this order.

In this case, for example, the surface of the side of the positive electrode current collector layer 1 adjacent to the positive electrode active material layer 2 includes a laminated part and extending parts. The laminated part is a portion overlapping the positive electrode active material layer 2. The extending parts are portions which extend further than the positive electrode active material layer 2. The surface roughness of the extending parts are greater than the surface roughness of the laminated part.

Furthermore, for example, the surface of the side of the negative electrode current collector layer 5 adjacent to the negative electrode active material layer 4 includes a laminated part and extending parts. The laminated part is a portion overlapping the negative electrode active material layer 4. The extending parts are portions which extend further than the negative electrode active material layer 4. As in the case of the positive electrode current collector 1 described above, the surface roughnesses of the extending parts are greater than the surface roughness of the laminated part.

Note that in the all-solid-state battery laminate 10 shown in FIG. 1, both the positive electrode current collector layer 1 and the negative electrode current collector layer 5 include laminate parts and extending parts. However, an embodiment in which only one of the positive electrode current collector layer 1 and the negative electrode current collector layer 5 includes a laminated part and an extending part is within the scope of the present disclosure.

Since changes in volume of the all-solid-state battery laminate occur during charging and discharging as described above, in conventional all-solid-state batteries in which the side surface of the all-solid-state battery laminate is covered with a resin layer, the adhesive portion between the all-solid-state battery laminate and the resin layer peels off, and as a result, there is a risk that the structure of the all-solid-state battery may become unstable. Further, if the structure of the all-solid-state battery becomes unstable, there are problems such as it is difficult for heat generated inside the battery to be dissipated to the outside of the battery through the resin layer.

In connection thereto, in the all-solid-state battery of the present disclosure, at least one surface of at least one of the positive electrode current collector layer and the negative electrode current collector layer comprises a laminated part and an extending part, and the surface roughness of the extending part is greater than the surface roughness of the laminated part. Thus, by providing an extending part having a high surface roughness on the current collector layer, adhesiveness between the current collector layer and the resin layer can be improved.

Furthermore, in the all-solid-state battery laminate, since the heat generated inside the battery tends to accumulate particularly in the current collector layer (positive electrode current collector layer or negative electrode current collector layer), in the all-solid-state battery of the present disclosure, by improving the adhesiveness between the current collector layer and the resin layer, it is easier for the heat generated in the battery to be dissipated to the outside of the battery through the resin layer.

### <Laminated Parts and Extending Parts>

The laminated parts and extending parts of the all-solid-state battery according to the present disclosure will be described in more detail below.

In the present disclosure, at least one surface of at least one of the positive electrode current collector layer and the negative electrode current collector layer includes a laminated part and an extending part. Furthermore, from the viewpoint of better exerting the effect of the present disclosure, at least one surface of each of the positive electrode current collector layers and the negative electrode current collector layers preferably include laminated parts and extending parts.

The laminated parts are portions overlapping other adjacent layers and the extending parts are portions extending further than other adjacent layers. In other words, when one surface of the positive electrode current collector layer includes a laminated part and an extending part, the laminated part is the portion overlapping the other layer adjacent to the one surface of the positive electrode current collector layer, e.g., the positive electrode active material layer, and the extending part is the portion extending further then the other layer adjacent to the one surface of the positive electrode current collector layer, e.g., the positive electrode active material layer. Note that, the same is true for the case in which one surface of the negative electrode current collector layer includes a laminated part and an extending part.

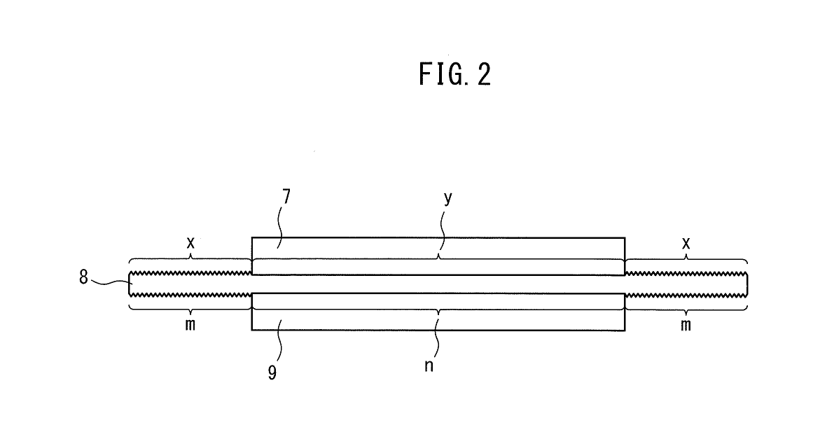

For example, FIG. 2 is a schematic view showing a laminate comprising a positive electrode active material layer 7, a positive electrode current collector layer 8, and a positive electrode active material layer 9 laminated in this order as a portion of the all-solid-state battery of the present disclosure. At this time, the surface of the side of the positive electrode current collector layer 8 adjacent to the positive electrode active material layer 7 includes a laminated part y and extending parts x. The laminated part y is the portion overlapping the positive electrode active material layer 7, which is adjacent to the positive electrode current collector layer 8, and the extending parts x are the portions extending further than the positive electrode active material layer 7, which is adjacent to the positive electrode current collector layer 8. In the present disclosure, the surface roughnesses of the extending parts x are greater than the surface roughness of the laminated part y. Note that, for convenience of explanation, in FIG. 2, the resin layer which covers the side surface of the all-solid-state battery laminate and the other portions of the all-solid-state battery have been omitted.

Furthermore, from the viewpoint of better exerting the effect of the present disclosure, it is preferable that both surfaces of at least one of the positive electrode current collector layer and the negative electrode current collector layer include laminated parts and extending parts.

For example, in the case of the laminate comprising a positive electrode active material layer 7, a positive electrode current collector layer 8, and a positive electrode active material layer 9 laminated in this order shown in FIG. 2, in the positive electrode current collector layer 8, in addition to the surface of the side adjacent to the positive electrode active material layer 7 including a laminated part y and extending parts x, the surface on the side adjacent to the positive electrode active material layer 9 preferably also includes a laminated part n and extending parts m. The laminated part n is the portion overlapping the positive electrode active material layer 9, which is adjacent to the positive electrode current collector 8, and the extending parts m are the portions extending further than the positive electrode active material layer 9, which is adjacent to the positive electrode current collector layer 8. The surface roughnesses of the extending parts m are greater than the surface roughness of the laminated part n.

Note that in the case in which both surfaces of at least one of the positive electrode current collector layer and the negative electrode current collector layer include laminated parts and extending parts, it is only necessary that the relationship between the surface roughnesses of the laminated part and the extending part on the same surface satisfy the relationship that “the surface roughness of the extending part is greater than the surface roughness of the laminated part”. For example, in the positive electrode current collector layer 8 shown in FIG. 2, it is only necessary to satisfy either the condition that the surface roughnesses of the extending parts x be greater than the surface roughness of the laminated part y or the condition that the surface roughnesses of the extending parts m be greater than the surface roughnesses of the laminated part n.

As long as the surface roughnesses of the laminated part and extending part in the same surface of the positive electrode current collector layer and/or the negative electrode current collector layer satisfy the above relationship, the surface roughnesses thereof are not particularly limited.

For example, the surface roughness of the extending part may be 1.01 times or more, 1.02 times or more, 1.03 times or more, 1.04 times or more, 1.05 times or more, 1.06 times or more, 1.07 times or more, 1.08 times or more, 1.09 times or more, 1.10 times or more, 1.50 times or more, 1.80 times or more, 2.00 times or more, or 2.50 times or more the surface roughness of the laminated part in the same surface. Furthermore, the upper limit of the surface roughness of the extending part is not particularly limited and any upper limit of the surface roughness can be used as long as the surface roughness can be imparted during production/machining.

The range of the surface roughness of the laminated part is not particularly limited and may be a typical surface roughness range of positive electrode current collector layers and negative electrode current collector layers obtained by known production processes or may be within the range of surface roughnesses appropriately applied based on the balance between the adhesion and the contact resistance of the positive electrode current collector layer and/or the negative electrode current collector layer and the respective active material layers adjacent thereto.

Furthermore, the laminated parts on the surfaces of at least one of the positive electrode current collector layer and the negative electrode current collector layer may have the same surface roughness or may have different surface roughnesses. From the viewpoint of convenience of production, it is preferable that the surface roughnesses thereof be the same. Likewise, the extending parts on each surface of at least one of the positive electrode current collector layer and the negative electrode current collector layer may have the same surface roughness or may have different surface roughnesses. From the viewpoint of convenience of production, it is preferable that the surface roughnesses thereof be the same. For example, in the positive electrode current collector layer 8 shown in FIG. 2, the laminated part y and the laminated part n may have the same surface roughnesses or may have different surface roughnesses. From the viewpoint of convenience of production, it is preferable that the surface roughnesses thereof be the same. Furthermore, the extending parts x and the extending parts m may have the same surface roughness or may have different surface roughnesses. From the viewpoint of convenience of production, it is preferable that the surface roughnesses thereof be the same.

In the present disclosure, the means for obtaining laminated parts and extending parts having different surface roughnesses on at least one surface of the positive electrode current collector layer and the negative electrode current collector layer is not particularly limited. For example, when producing the positive electrode current collector layer and the negative electrode current collector layer, or after producing the positive electrode current collector layer and the negative electrode current collector layer, laminated parts and extending parts having the desired surface roughness can be obtained by embossing during roll-pressing or the like. Alternatively, when producing the positive electrode current collector layer and the negative electrode current collector layer, or after producing the positive electrode current collector layer and the negative electrode current collector layer, laminated parts and extending parts having the desired surface roughness can be obtained by applying a plating.

Since the areas of the laminated parts of the surfaces of at least one of the positive electrode current collector layer and the negative electrode current collector layer are determined by the areas of the other layers adjacent thereto, the areas may be the same or may be different. For the same reason, the areas of the extending parts of the surfaces of at least one of the positive electrode current collector layer and the negative electrode current collector layer may be the same or may be different. For example, in the positive electrode current collector layer 8 shown in FIG. 2, the area of the laminated part y and the area of the laminated part n may be the same or may be different. Furthermore, the areas of the extending parts x and the areas of the extending parts m may be the same or may be different.

Further, from the viewpoint of better exerting the effect of the present disclosure, it is preferable that both surfaces of all of the positive electrode current collector layers and the negative electrode current collector layers other than the outermost surfaces of the positive electrode current collector layer and/or negative electrode current collector layer arranged on the outermost layers include laminated parts and extending parts.

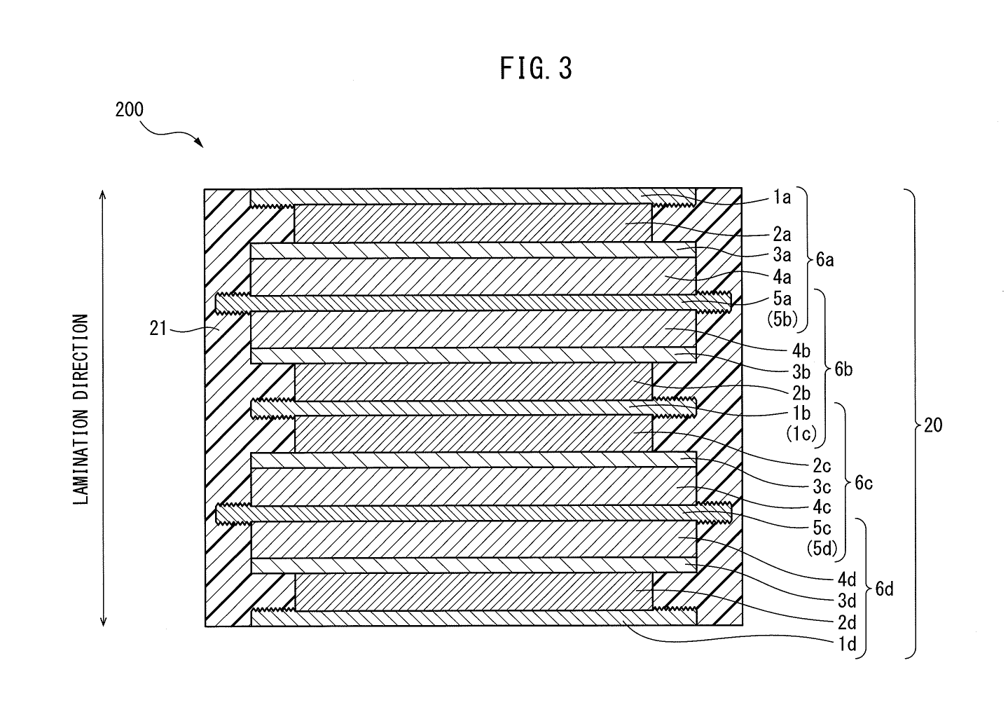

For example, FIG. 3 is a schematic cross-sectional view showing an example of the all-solid-state battery of the present disclosure. The all-solid-state battery 200 shown in FIG. 3 comprises an all-solid-state battery laminate 20 and a resin layer 21 covering the side surface of the all-solid-state battery laminate 20. In this case, the all-solid-state battery laminate 20 comprises all-solid-state unit cells 6a, 6b, 6c, and 6d, and in each of the all-solid-state unit cells 6a, 6b, 6c, and 6d, all of the positive electrode current collector layers and the negative electrode current collector layers include laminated parts and extending parts. The surface roughnesses of the extending parts are greater than the surface roughnesses of the laminated parts. As a result, the adhesiveness between the all-solid-state battery laminate 20 and the resin layer 21 can be improved and the all-solid-state battery 200 can be structurally stabilized.

### <All-Solid-State Battery Laminate>

In the present disclosure, the all-solid-state battery laminate can include one or more all-solid-state unit cells. Furthermore, each all-solid-state unit cell comprises a positive electrode current collector layer, a positive electrode active material layer, a solid electrolyte layer, a negative electrode active material layer, and a negative electrode current collector layer laminated in this order.

For example, the all-solid-state battery laminate 20 shown in FIG. 3 comprises four all-solid-state unit cells 6a, 6b, 6c, and 6d. Furthermore, the all-solid-state unit cell 6a comprises a positive electrode current collector 1a, a positive electrode active material layer 2a, a solid electrolyte layer 3a, a negative electrode active material layer 4a, and a negative electrode current collector 5a (5b) laminated in this order. The all-solid-state unit cell 6b comprises the negative electrode current collector layer 5a (5b), a negative electrode active material layer 4b, a solid electrolyte layer 3b, a positive electrode active material layer 2b, and a positive electrode current collector layer 1b (1c) laminated in this order. The all-solid-state unit cell 6c comprises the positive electrode current collector layer 1b (1c), a positive electrode active material layer 2c, a solid electrolyte layer 3c, a negative electrode active material layer 4c, and a negative electrode current collector layer 5c (5d) laminated in this order. The all-solid-state unit cell 6d comprises the negative electrode current collector layer 5c (5d), a negative electrode active material layer 4d, a solid electrolyte layer 3d, a positive electrode active material layer 2d, and a positive electrode current collector layer 1d laminated in this order.

Furthermore, when the all-solid-state battery laminate comprises two or more all-solid-state unit cells, the all-solid-state battery laminate may be a monopolar-type all-solid-state battery laminate or may be a bipolar-type all-solid-state battery laminate.

In the case in which the all-solid-state battery laminate is a monopolar-type all-solid-state battery laminate, a monopolar-type configuration in which two all-solid-state unit cells adjacent to each other in the lamination direction share a positive electrode current collector layer or a negative electrode current collector layer may be used. For example, as shown in FIG. 3, the adjacent all-solid-state unit cells 6a and 6b share the negative electrode current collector layer 5a (5b), the adjacent all-solid-state unit cells 6b and 6c share the positive electrode current collector layer 1b (1c), and the adjacent all-solid-state unit cells 6c and 6d share the negative electrode current collector layer 5c (5d). The monopolar-type all-solid-state battery laminate 20 is composed of a combination of these all-solid-state unit cells 6a, 6b, 6c, and 6d.

In the case in which the all-solid-state battery laminate is a bipolar-type all-solid-state battery laminate, a bipolar-type configuration in which two adjacent all-solid-state unit cells adjacent to each other in the lamination direction share a positive electrode/negative electrode current collector layer used as both the positive electrode and negative electrode current collector layers may be used. Thus, for example, the all-solid-state battery laminate may be a laminate of three all-solid-state unit cells sharing positive electrode/negative electrode current collector layers used as both the positive electrode and negative electrode current collector layers. Specifically, the all-solid-state battery laminate can comprise a positive electrode current collector layer, a positive electrode active material layer, a solid electrolyte layer, a negative electrode active material layer, a positive electrode/negative electrode current collector layer, a positive electrode active material layer, a solid electrode layer, a negative electrode active material layer, a positive electrode/negative electrode current collector layer, a positive electrode active material layer, a solid electrolyte layer, a negative electrolyte layer, and a negative electrode current collector layer laminated in this order (not shown). Furthermore, in this case, since it is used as both the positive electrode and negative electrode current collector layers, the “positive electrode/negative electrode current collector layer” can be applied to either the “positive electrode current collector layer” or the “negative electrode current collector layer” of the present disclosure. In other words, at least one surface of at least one “positive electrode/negative electrode current collector layer” can comprise the aforementioned laminated part and extending part.

In the present disclosure, the positive electrode active material layer and the negative electrode active material layer preferably have different areas. In particular, the area of the negative electrode active material layer is preferably larger than the area of the positive electrode active material layer. As a result, when charging, lithium ions can reliably move from the positive electrode active material layer to the negative electrode active material layer.

Furthermore, the all-solid-state battery of the present disclosure may include positive electrode current collector tabs electrically connected to the positive electrode current collector layer and may include negative electrode current collector tabs electrically connected to the negative electrode current collector layer. In this case, these current collector tabs may protrude from the resin layer. According to this configuration, electrical power generated in the all-solid-state battery laminate can be extracted to the outside via the current collector tabs.

The positive electrode current collector layer may include positive electrode current collector protrusion parts which protrude in the surface direction, and the positive electrode current collector protrusion parts may be electrically connected to the positive electrode current collector tabs. Likewise, the negative electrode current collector layer may include negative electrode current collector protrusion parts which protrude in the surface direction, and the negative electrode current collector protrusion parts may be electrically connected to the negative electrode current collector tabs.

Furthermore, in the all-solid-state battery of the present disclosure, the all-solid-state battery laminate is preferably retrained in the lamination direction. As a result, when charging and discharging, the conductivity of ions and electrons within each layer and between each layer of the all-solid-state battery laminate can be improved, which can further promote the battery reaction.

Each material of the all-solid-state battery laminate will be described in detail below. Note that for the ease of understanding the present disclosure, each material of the all-solid-state battery laminate of an all-solid-state lithium ion secondary battery will be described as an example. However, the all-solid-state battery of the present disclosure is not limited to lithium ion secondary batteries and can be widely applied.

### (Positive Electrode Current Collector Layer)

The conductive material used in the positive electrode current collector layer is not particularly limited and any conductive material which can be used in all-solid-state batteries can be suitably used. For example, the conductive material used in the positive electrode current collector layer may be SUS, aluminum, copper, nickel, iron, titanium, carbon, or the like. However, the conductive material is not limited thereto.

The form of the positive electrode current collector layer of the present disclosure is not particularly limited, and can be, for example, a foil, a plate, a mesh, or the like. From among these, a foil is preferable.

### (Positive Electrode Active Material Layer)

The positive electrode active material layer includes at least a positive electrode active material, and preferably further includes a solid electrolyte, which will be described later. In addition thereto, additives which are used in the positive electrode active material layer of all-solid-state batteries such as, for example, a conductive aid or a binder, can be included in accordance with the intended use or application thereof.

The material of the positive electrode active material is not particularly limited. For example, the positive electrode active material may be lithium cobalt oxide (LiCoO₂), lithium nickel oxide (LiNiO₂), lithium manganate (LiMn₂O₄), LiCo_{1/3}Ni_{1/3}Mn_{1/3}O₂, or a heterogeneous-element-substituted Li—Mn spinel represented by Li₁₊ₓMn_{2-x-y}M_{y}O₄ (wherein M is at least one metal element selected from Al, Mg, Co, Fe, Ni and Zn). However, the material of the positive electrode active material layer is not limited thereto.

The conductive aid is not particularly limited. For example, the conductive aid may be a carbon material, such as VGCF (vapor grown carbon fiber) or carbon nanofibers, or a metal material. However, the conductive aid is not limited thereto.

The binder is not particularly limited. For example, the binder may be a material such as polyvinylidene fluoride (PVdF), carboxymethyl cellulose (CMC), butadiene rubber (BR), styrene butadiene rubber (SBR), or combinations thereof. However, the binder is not limited thereto.

### (Solid Electrolyte Layer)

The solid electrolyte layer includes at least a solid electrolyte. The solid electrolyte is not particularly limited and any material commonly used as the solid electrolyte in all-solid-state batteries can be used. For example, the solid electrolyte may be a sulfide solid electrolyte, oxide solid electrolyte, or polymeric electrolyte. However, the solid electrolyte is not limited thereto.

Examples of the sulfide solid electrolyte include sulfide-based amorphous solid electrolytes, sulfide-based crystalline solid electrolytes, or aldylodyte-type solid electrolytes. However, the sulfide solid electrolyte is not limited thereto. Examples of specific sulfide solid electrolytes include Li₂S—P₂S₅-type compounds (such as Li₇P₃S₁₁, Li₃PS₄, or Li₈P₂S₉), Li₂S—SiS₂, LiI—Li₂S—SiS₂, LiI—Li₂S—P₂S₅, LiI—LiBr—Li₂S—P₂S₅, Li₂S—P₂S₅—GeS₂ (such as Li₁₃GeP₃S₁₆ or Li₁₀GeP₂S₁₂), LiI—Li₂S—P₂O₅, LiI—Li₃PO₄—P₂S₅, Li₇₋ₓPS₆₋ₓClₓ, or combinations thereof. However, the sulfide solid electrolyte is not limited thereto.

Examples of the oxide solid electrolyte include Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, or Li₃₊ₓPO₄₋ₓNₓ (LiPON). However, the oxide solid electrolyte is not limited to these materials.

### (Polymeric Electrolyte)

Examples of the polymeric electrolyte include polyethylene oxide (PEO), polypropylene oxide (PPO), and copolymers thereof. However, the polymeric electrolyte is not limited thereto.

The solid electrolyte may be a glass or a crystallized glass (glass ceramic). Furthermore, in addition to the above-described solid electrolytes, the solid electrolyte layer may include a binder as necessary. Specific examples thereof are the same as the “binders” described above for the “positive electrode active material layer”, and thus, a description thereof has been omitted.

### (Negative Electrode Active Material Layer)

The negative electrode active material layer includes at least a negative electrode active material and preferably further includes a solid electrolyte as described above. In addition thereto, depending on the purpose or application thereof, for example, additives commonly used in the negative electrode active material layer of all-solid-state batteries, such as a conductive aid or binder, can be included.

The material of the negative electrode active material is not particularly limited. The material is preferably capable of occluding and releasing metal ions such as lithium ions. For example, the negative electrode active material may be an alloy-based negative electrode active material or a carbon material. However, the material of the negative electrode active material layer is not limited thereto.

The alloy-based negative electrode active material is not particularly limited, and, for example, a Si alloy-based negative electrode active material or a Sn alloy-based negative electrode active material can be used. The Si alloy-based negative electrode active material can be silicon, silicon oxide, silicon carbide, silicon nitride, or a solid solution thereof. Furthermore, the Si alloy-based negative electrode active material can include an element other than silicon, such as Fe, Co, Sb, Bi, Pb, Ni, Cu, Zn, Ge, In, Sn, or Ti. The Sn alloy-based negative electrode active material can be tin, tin oxide, tin nitride, or a solid solution thereof. Furthermore, the Sn alloy-based negative electrode active material can include an element other than tin, such as Fe, Co, Sb, Bi, Pb, Ni, Cu, Zn, Ge, In, Ti, or Si. Among these alloy-based negative electrode active materials, a Si alloy-based negative electrode active material is preferable.

The carbon material is not particularly limited and can be, for example, a hard carbon, a soft carbon, or graphite.

Regarding the solid electrolyte and other additives such as the conductive aid and binder used in the negative electrode active material layer, those described above in the sections “positive electrode active material layer” and “solid electrolyte layer” can be appropriately used.

### (Negative Electrode Current Collector Layer)

The conductive material used in the negative electrode current collector layer is not particularly limited and any conductive material which can be used in all-solid-state batteries can be suitably used. For example, the conductive material used in the negative electrode current collector layer may be SUS, aluminum, copper, nickel, iron, titanium, carbon, or the like. However, the conductive material is not limited thereto.

The form of the negative electrode current collector layer is not particularly limited, and can be, for example, a foil, a plate, a mesh, or the like. From among these, a foil is preferable.

### <Resin Layer>

In the present disclosure, the material of the resin layer is not particularly limited and the material may be the same as the insulating resin material used for general all-solid-state batteries.

For example, the material of the resin layer may be a curable resin or a thermoplastic resin. Furthermore, the curable resin may be a thermosetting resin, a photocurable resin (for example, a UV-curing resin) or an electron beam-curable resin. More specifically, the material of the resin layer may be, for example, an epoxy resin, an acrylic resin, a polyimide resin, a polyester resin, a polypropylene resin, a polyamide resin, a polystyrene resin, a polyvinyl chloride resin, or a polycarbonate resin. However, the material of the resin layer is not limited thereto.

In the present disclosure, the resin layer covers the side surface of the all-solid-state battery laminate. As a result, the outer surface of the all-solid-state battery of the present disclosure may not include an outer casing such as a laminate film or a metal can. Thus, the all-solid-state battery of the present disclosure is more compact than conventional all-solid-state batteries, in which an outer casing is necessary, and thereby results in an improvement in the energy density of the battery. However, an embodiment of the present disclosure may further include an outer casing.

For example, as in the all-solid-state battery 200 shown in FIG. 3, the upper end surface and the lower end surface in the lamination direction are the positive electrode current collector layers 1a and 1d, and only the side surface of the all-solid-state battery laminate 20 is covered by the resin layer 21 having a multi-layer structure. Depending on the lamination order of the all-solid-state battery laminate, the upper end surface and the lower end surface in the lamination direction may not be limited to positive electrode current collector layers but may be negative electrode current collector layers.

Furthermore, the all-solid-state battery of the present disclosure may be an all-solid-state battery in which the upper end surface and the lower end surface in the lamination direction of the all-solid-state battery laminate are covered by films or the like and the side surface of at least the all-solid-state battery laminate is covered by the resin layer. Moreover, the all-solid-state battery of the present disclosure may be an all-solid-state battery in which the upper end surface and/or the lower end surface in the lamination direction of the all-solid-state battery laminate are covered by the resin layer.

### <<All-Solid-State Battery Type>>

In the present disclosure, the type of the all-solid-state battery can be an all-solid-state lithium ion battery, an all-solid-state sodium ion battery, an all-solid-state magnesium ion battery, or an all-solid-state calcium ion battery. From among these, an all-solid-state lithium ion battery or an all-solid-state sodium ion battery is preferable and an all-solid-state lithium ion battery is particularly preferable.

Furthermore, the all-solid-state battery of the present disclosure may be a primary battery or may be a secondary battery. From among these, a secondary battery is preferable. Secondary batteries can be repeatedly charged and discharged and can be used as, for example, in-vehicle batteries. Thus, it is preferable that the all-solid-state battery of the present disclosure be an all-solid-state lithium ion secondary battery.

### REFERENCE SIGNS LIST

1, 1a, 1b, 1c, 1d positive electrode current collector layer
2, 2a, 2b, 2c, 2d positive electrode active material layer
3, 3a, 3b, 3c, 3d solid electrolyte layer
4, 4a, 4b, 4c, 4d negative electrode active material layer
5, 5a, 5b, 5c, 5d negative electrode current collector layer
7, 9 positive electrode active material layer
8 positive electrode current collector layer
10, 20 all-solid-state battery laminate
11, 21 resin layer
100, 200 all-solid-state battery

1. An all-solid-state battery, comprising:
an all-solid-state battery laminate comprising at least one all-solid-state unit cell in which a positive electrode current collector layer, a positive electrode active material layer, a solid electrolyte layer, a negative electrode active material layer, and a negative electrode current collector layer are laminated in this order, and
a resin layer covering a side surface of the all-solid-state battery laminate, wherein
wherein at least one surface of at least one of the positive electrode current collector layer and the negative electrode current collector layer includes a laminated part and an extending part,
wherein the laminated part is a portion which overlaps another adjacent layer, and the extending part is a portion which extends beyond the other adjacent layer, and
wherein the surface roughness of the extending part is greater than the surface roughness of the laminated part.

2. The all-solid-state battery according to claim 1, wherein at least one surface of each of the positive electrode current collector layers and the negative electrode current collector layers includes the laminated part and the extending part.

3. The all-solid-state battery according to claim 1, wherein both surfaces of at least one of the positive electrode current collector layer and the negative electrode current collector layer include the laminate part and the extending part.

4. The all-solid-state battery according to claim 1, wherein the positive electrode active material layer and the negative electrode active material layer have different areas.

5. The all-solid-state battery according to claim 1, wherein the area of the negative electrode active material layer is greater than the area of the positive electrode active material layer.

6. The all-solid-state battery according to claim 1, wherein the material of the resin layer is a curable resin or a thermoplastic resin.

7. The all-solid-state battery according to claim 1, wherein the all-solid-state battery laminate is restrained in the lamination direction.

8. The all-solid-state battery according to claim 1, wherein the all-solid-state battery is an all-solid-state lithium ion secondary battery.
